(19) United States
(12) Patent Application Publication
(10) Pub. No.: US 2026/0046596 A1
(43) Pub. Date: Feb. 12, 2026

(54) HANDLING DISASTER ROAMING SERVICE IN WIRELESS NETWORK

(71) Applicant: Samsung Electronics Co., Ltd., Suwon-si, Gyeonggi-do (KR)

(72) Inventors: Lalith KUMAR, Bangalore (IN); Aman AGARWAL, Bangalore (IN); Kailash Kumar JHA, Bangalore (IN); Mahmoud WATFA, Middlesex (GB)

(21) Appl. No.: 19/101,429

(22) PCT Filed: Sep. 27, 2023
(86) PCT No.: PCT/KR2023/015054

§ 371 Date: Feb. 5, 2025

(30) Foreign Application Priority Data
Sep. 29, 2022 (IN) 202241056008
Sep. 1, 2023 (IN) 202241056008

(51) Int. Cl. H04W 4/90; H04W 8/02; H04W 12/106; H04W 48/18; H04W 60/04; H04W 76/18

(52) U.S. Cl. CPC H04W 4/90; H04W 8/02; H04W 12/106; H04W 48/18; H04W 60/04; H04W 76/18

(57) ABSTRACT

The disclosure relates to a 5G or 6G communication system for supporting a higher data transmission rate. Embodiments herein provide methods for handling disaster roaming service in network by UE. The method includes determining whether the UE receives a NAS message without integrity protection from a combination of first PLMN and second PLMN upon sending a registration request message to combination of first PLMN and second PLMN after expiry of a timer. In an embodiment, the method includes determining a count of attempt to combination of first PLMN and second PLMN meets a predefined threshold and determining that first PLMN is genuine network in which UE is not allowed to get disaster roaming service and blocking to retry on combination of first PLMN and second PLMN in response to receiving NAS message without integrity protection from combination of first PLMN and second PLMN upon sending a registration request message to the combination of first PLMN and second PLMN after expiry of timer.

### TECHNICAL FIELD

The present invention relates to a wireless communication method and a wireless communication network, and more particularly to a method and a User Equipment (UE) for handling a non-integrity protected message in a disaster situation in the wireless communication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The purpose of a Minimization of service interruption (MINT) is to minimize interruption of service to users when a wireless communication network to which these users are subscribed cannot provide service due to a disaster such as e.g. a fire, by enabling the users to obtain service on other networks, while at the same time protecting those other networks from congestion.

In the description, PLMN D or PLMN-D is subject to disaster (i.e. PLMN-D is a PLMN with disaster condition) and PLMN A or PLMN-A is alive and not subject to disaster. The PLMN-A may provide disaster roaming service to the users of the PLMN-D (i.e. to the Disaster Inbound roamers of the PLMN-D).

FIG. 1 is a signalling diagrams illustrating a scenario of how shall a UE (100) determines whether a 5GMM reject cause value, according to the prior arts.

Consider, PLMN-D1 is an allowable PLMN for the UE (100) i.e. PLMN-D1 is not part of UE's Forbidden PLMN List (FPLMN List) and PLMN-D1 has faced disaster condition. PLMN-D2 is an allowable PLMN for the UE (100) i.e. PLMN-D2 is not part of UE's Forbidden PLMN List (FPLMN List) and PLMN-D2 has faced disaster condition.

A PLMN-A1 is part of UE's Forbidden PLMN List (FPLMN List) or present in a list of “forbidden PLMNs” or present in the list of “forbidden PLMNs for GPRS service”. The PLMN-A1 is alive and is broadcasting an indication of accessibility for a disaster roaming service to the UE (100). The PLMN-A can optionally broadcast a “list of one or more PLMN(s) with disaster condition (for e.g. PLMN-D1, PLMN-D2) for which the disaster roaming is offered by the available PLMN”.

The UE (100) supporting Disaster Roaming or Minimization of Service Interruption (MINT), in a disaster condition, can select and register (through any Access Stratum (AS) or Non Access Stratum (NAS) signalling messages, for example-Registration Request message etc) for disaster roaming services using a 5GS Registration Type value as “disaster roaming initial registration” or using 5GS Registration Type value as “disaster roaming mobility registration updating” on a PLMN (PLMN-A1) which is present in the Forbidden PLMN List (FPLMN List) of the UE (100) and providing disaster roaming services to the UE (100) on behalf of the determined PLMN with disaster condition (for e.g. PLMN-D1, which is allowable or not a part of UE's Forbidden PLMN List and has faced the disaster condition).

However, there may be a fake network (200a) or spoofing network (any network entity such as gNB or Access and Mobility Management Function (AMF) etc) which may pretend to behave as the network entity for PLMN-A1. When the UE (100) is registering on the PLMN-A1 for the disaster roaming services for the PLMN-D1 which has faced disaster condition, the fake network (200a) (for e.g. fake network (200a) behaving as PLMN-A1) may reject the registration request of the UE (100) (through any AS or NAS signalling messages, for example-Registration Reject message etc) with the 5GMM reject cause value #80 (Disaster roaming for the determined PLMN with disaster condition not allowed).

When the UE (100) receives the 5GMM reject cause value #80 (Disaster roaming for the determined PLMN with disaster condition not allowed) for the disaster roaming registration, the UE (100) may not know whether the reject cause value has been initiated from a genuine network (For example-PLMN-A1 i.e., PLMN-A1 genuinely does not support providing disaster roaming services for the determined PLMN with disaster condition (e.g. PLMN-D1) to the UE (100)) or the reject cause value has been initiated from the fake network (200a) (for e.g. fake network (200a) behaving as PLMN-A1) which is pretending to behave as the Network Entity for PLMN-A1 and wrongly providing the 5GMM reject cause value #80 to the UE (100) even though the PLMN-A1 supports providing disaster roaming services for the determined PLMN with disaster condition (e.g. PLMN-D1) to the UE (100).

a) The UE (100), in either of the cases, shall not be able to determine whether the 5GMM reject cause value #80 is received from the PLMN-A1 (i.e. genuine Network) or from the fake network (200a) (for e.g. fake network (200a) behaving as PLMN-A1).

b) The UE (100) shall not attempt to register for disaster roaming on the PLMN (i.e. PLMN-A1) for the determined PLMN with disaster condition (i.e. PLMN-D1) for a period in the range of 12 to 24 hours even though the PLMN-A1 supports providing disaster roaming services for the determined PLMN with disaster condition (e.g. PLMN-D1) to the UE (100).

c) The UE (100) shall not attempt to register for disaster roaming on the PLMN (i.e. PLMN-A1) for a period in the range of 3 to 10 minutes (for example-for some other determined PLMN with disaster condition (for e.g. PLMN-D2)).

The UE (100) is unable to get disaster roaming service from the PLMN-A1 for the determined PLMN with the disaster condition (PLMN-D1) for the period in the range of 12 to 24 hours even though the PLMN-A1 supports providing disaster roaming services for the determined PLMN with disaster condition (e.g. PLMN-D1) to the UE (100).

Currently, the existing methods and systems are not defined how the UE (100) shall determine whether the 5GMM reject cause value #80 (Disaster roaming for the determined PLMN with disaster condition not allowed) has been received from the PLMN-A1 (i.e. genuine Network) or from the fake network (200a) (for e.g. fake network (200a) behaving as PLMN-A1) and existing methods and systems are not defined what shall the UE (100) do when the UE (100) receives the 5GMM reject cause value #80 from the fake network (200a) (for e.g. fake network (200a) behaving as PLMN-A1).

As shown in FIG. 1, at step 1, the UE (100) detects that the disaster happened on the PLMN-D1 and PLMN-D2. At step 2, the PLMN-A1 broadcasts an indication of accessibility for Disaster Roaming Service (optionally broadcast a “list of one or more PLMN(s) with disaster condition (for e.g. PLMN-D1, PLMN-D2) for which disaster roaming is offered by the available PLMN” (i.e. PLMNs with disaster condition for which PLMN-A1 is providing disaster roaming services). At step 3, the UE (100) registers using 5GS Registration Type value as “disaster roaming initial registration” or using 5GS Registration Type value as “disaster roaming mobility registration updating” on PLMN A1 for Disaster Roaming service for the determined PLMN with disaster condition (PLMN-D1).

At step 4, the fake network or spoofing network (any Network Entity such as gNB or AMF etc) which may pretend to behave as the Network Entity for PLMN-A1, on which UE is registering for Disaster Roaming services for PLMN-D1 which has faced disaster condition, rejects the registration request of the UE (through any AS or NAS signalling messages, for example-Registration Reject message etc) with the 5GMM reject cause value #80 (Disaster roaming for the determined PLMN with disaster condition not allowed).

At step 5, when the UE (100) receives the 5GMM reject cause value #80 (Disaster roaming for the determined PLMN with disaster condition not allowed) for the disaster roaming registration, the UE may not know whether the reject cause value has been initiated from a genuine Network (For example-PLMN-A1 i.e. PLMN-A1 genuinely does not support providing disaster roaming services for the determined PLMN with disaster condition (e.g. PLMN-D1) to the UE) or the reject cause value has been initiated from a Fake Network (for e.g. Fake Network behaving as PLMN-A1) which is pretending to behave as the Network Entity for PLMN-A1 and wrongly providing the 5GMM reject cause value #80 to the UE even though the PLMN-A1 supports providing disaster roaming services for the determined PLMN with disaster condition (e.g. PLMN-D1) to the UE.

a) The UE (100), in either of the cases, shall not be able to determine whether the 5GMM reject cause value #80 is received from the PLMN-A1 (i.e. genuine Network) or from a Fake Network (for e.g. Fake Network behaving as PLMN-A1).

b) The UE (100) will not attempt to register for disaster roaming on this PLMN (i.e. PLMN-A1) for the determined PLMN with disaster condition (i.e. PLMN-D1) for a period in the range of 12 to 24 hours even though the PLMN-A1 supports providing disaster roaming services for the determined PLMN with disaster condition (e.g. PLMN-D1) to the UE.

c) The UE (100) will not attempt to register for disaster roaming on this PLMN (i.e. PLMN-A1) for a period in the range of 3 to 10 minutes (for example-for some other determined PLMN with disaster condition (for e.g. PLMN-D2)).

At step 6, the UE (100) is unable to get disaster roaming service from PLMN-A1 for the determined PLMN with disaster condition (PLMN-D1) for a period in the range of 12 to 24 hours even though the PLMN-A1 supports providing disaster roaming services for the determined PLMN with disaster condition (e.g. PLMN-D1) to the UE.

Currently, it is not defined how the UE shall determine whether the 5GMM reject cause value #80 (Disaster roaming for the determined PLMN with disaster condition not allowed) has been received from the PLMN-A1 (i.e. genuine Network) or from a Fake Network (for e.g. Fake Network behaving as PLMN-A1) and it is not defined what shall the UE do when the UE receives the 5GMM reject cause value #80 from a Fake Network (for e.g. Fake Network behaving as PLMN-A1).

It is desired to address the above mentioned disadvantages or other short comings or at least provide a useful alternative.

### DISCLOSURE OF INVENTION

### Technical Problem

The purpose of this application is to be able to solve at least one of the drawbacks of the prior art.

The principal object of the embodiments herein is to provide a method and a UE for handling a non-integrity protected message in a disaster situation in a wireless network.

Another object of the embodiments herein is to determine whether the UE receives a NAS message without integrity protection from the combination of a first PLMN and a second PLMN upon sending a registration request message to the combination of the first PLMN and the second PLMN after expiry of a timer.

Another object of the embodiments herein is to determine a count of attempt to the combination of the first PLMN and the second PLMN meets a predefined threshold and determining that the first PLMN is genuine network in which the UE is not allowed to get the disaster roaming service and blocking to retry on the combination of the first PLMN and the second PLMN in response to receiving the NAS message without integrity protection from the combination of the first PLMN and the second PLMN upon sending the registration request message to the combination of the first PLMN and the second PLMN after expiry of the timer.

Another object of the embodiments herein is to determine the count of attempt to the combination of the first PLMN and the second PLMN has not met a predefined threshold, increasing the counter, starting the timer, blocking to retry for the disaster roaming service on the combination of the first PLMN and the second PLMN for the duration of the timer, performing the PLMN selection in response to receiving the NAS message without integrity protection from the combination of the first PLMN and the second PLMN upon sending the registration request message to the combination of the first PLMN and the second PLMN after expiry of the timer.

Another object of the embodiments herein is to determine that the NAS message with the reject cause #80 message is from a fake network and combination of the first PLMN and the second PLMN is allowed for the disaster roaming service in response to receiving the integrity protected registration accept from the combination of the first PLMN and the second PLMN upon sending the registration message to the combination of the first PLMN and the second PLMN after expiry of the timer.

Another object of the embodiments herein is to determine that the combination of the first PLMN and the second PLMN is not allowed for the disaster roaming service in response to receiving the NAS reject message with the reject cause #80 which has been successfully integrity checked from the combination of the first PLMN and the second PLMN upon sending the registration message to the combination of the first PLMN and the second PLMN after expiry of the timer.

### Solution to Problem

Accordingly the embodiment herein is to provide a method for handling a disaster roaming service in a wireless network. The method includes receiving, by a UE, a Non-access stratum (NAS) message without integrity protection with a reject cause #80 from a first Public Land Mobile Network (PLMN). Further, the method includes maintaining, by the UE, a count of attempt of a combination of the first PLMN and a second PLMN upon determining the NAS message without integrity protection is received with the reject cause #80. Further, the method includes starting, by the UE, a timer at the UE, blocking to retry for the disaster roaming service on the combination of the first PLMN and the second PLMN for the duration of the timer, and performing a PLMN selection. Further, the method includes unblocking the combination of the first PLMN and the second PLMN for the disaster roaming service at the expiry of the timer. Further, the method includes determining, by the UE, whether the UE receives a NAS message without integrity protection from the combination of the first PLMN and the second PLMN upon sending a registration request message to the combination of the first PLMN and the second PLMN after expiry of the timer. In an embodiment, the method includes determining the count of attempt to the combination of the first PLMN and the second PLMN meets a predefined threshold and determining that the first PLMN is genuine network in which the UE is not allowed to get the disaster roaming service and blocking to retry on the combination of the first PLMN and the second PLMN in response to receiving the NAS message without integrity protection from the combination of the first PLMN and the second PLMN upon sending the registration request message to the combination of the first PLMN and the second PLMN after expiry of the timer. In an embodiment, the method includes determining the count of attempt to the combination of the first PLMN and the second PLMN has not met a predefined threshold, increasing the counter, starting the timer, blocking to retry for the disaster roaming service on the combination of the first PLMN and the second PLMN for the duration of the timer, performing the PLMN selection in response to receiving the NAS message without integrity protection from the combination of the first PLMN and the second PLMN upon sending the registration request message to the combination of the first PLMN and the second PLMN after expiry of the timer. In an embodiment, the method includes determining that the NAS message with the reject cause #80 message is from a fake network and combination of the first PLMN and the second PLMN is allowed for the disaster roaming service in response to receiving the integrity protected registration accept from the combination of the first PLMN and the second PLMN upon sending the registration message to the combination of the first PLMN and the second PLMN after expiry of the timer. In an embodiment, the method includes determining that the combination of the first PLMN and the second PLMN is not allowed for the disaster roaming service in response to receiving the NAS reject message with the reject cause #80 which has been successfully integrity checked from the combination of the first PLMN and the second PLMN upon sending the registration message to the combination of the first PLMN and the second PLMN after expiry of the timer.

In an embodiment, the without integrity protection NAS message is at least one of a registration reject message or a service reject message which is not integrity protected.

In an embodiment, the integrity protected NAS message is at least one of a registration reject message and a registration accept message which has been successfully integrity checked by the NAS message.

In an embodiment, the counter is a PLMN-specific attempt counter for the determined PLMN with the disaster condition.

In an embodiment, the UE is not allowed to attempt for the disaster roaming service on a combination of the first PLMN and the second PLMN by setting the counter to a UE implementation specific maximum value.

In an embodiment, the first PLMN is a selected PLMN on which the registration is attempted by the UE for the disaster roaming service. The second PLMN is a UE selected PLMN with a disaster condition.

In an embodiment, the timer is a timer T3247.

Accordingly the embodiment herein is to provide a UE for handling a disaster roaming service in a wireless network. The UE includes a disaster roaming service controller communicatively coupled to a memory and a processor. The disaster roaming service controller receives a NAS message without integrity protection with a reject cause #80 from a first PLMN. Further, the disaster roaming service controller maintains a count of attempt of a combination of the first PLMN and a second PLMN upon determining the NAS message without integrity protection is received with the reject cause #80. Further, the disaster roaming service controller starts a timer at the UE, blocks to retry for the disaster roaming service on the combination of the first PLMN and the second PLMN for the duration of the timer, and performs a PLMN selection. Further, the disaster roaming service controller unblocks the combination of the first PLMN and the second PLMN for the disaster roaming service at the expiry of the timer. Further, the disaster roaming service controller determines whether the UE receives a NAS message without integrity protection from the combination of the first PLMN and the second PLMN upon sending a registration request message to the combination of the first PLMN and the second PLMN after expiry of the timer. In an embodiment, the disaster roaming service controller determines the count of attempt to the combination of the first PLMN and the second PLMN meets a predefined threshold and determines that the first PLMN is genuine network in which the UE is not allowed to get the disaster roaming service and blocking to retry on the combination of the first PLMN and the second PLMN in response to receiving the NAS message without integrity protection from the combination of the first PLMN and the second PLMN upon sending the registration request message to the combination of the first PLMN and the second PLMN after expiry of the timer. In an embodiment, the disaster roaming service controller determines the count of attempt to the combination of the first PLMN and the second PLMN has not met a predefined threshold, increases the counter, starts the timer, blocks to retry for the disaster roaming service on the combination of the first PLMN and the second PLMN for the duration of the timer, performs the PLMN selection in response to receiving the NAS message without integrity protection from the combination of the first PLMN and the second PLMN upon sending the registration request message to the combination of the first PLMN and the second PLMN after expiry of the timer. In an embodiment, the disaster roaming service controller determines that the NAS message with the reject cause #80 message is from a fake network and combination of the first PLMN and the second PLMN is allowed for the disaster roaming service in response to receiving the integrity protected registration accept from the combination of the first PLMN and the second PLMN upon sending the registration message to the combination of the first PLMN and the second PLMN after expiry of the timer. In an embodiment, the disaster roaming service controller determines that the combination of the first PLMN and the second PLMN is not allowed for the disaster roaming service in response to receiving the NAS reject message with the reject cause #80 which has been successfully integrity checked from the combination of the first PLMN and the second PLMN upon sending the registration message to the combination of the first PLMN and the second PLMN after expiry of the timer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### Advantageous Effects of Invention

Embodiments of the present disclosure provides methods and apparatus for determine whether the 5GMM reject message received is from the genuine network or a fake network.

Embodiments of the present disclosure provides methods and apparatus for handling method for 5GMM reject message which is not integrity protected.

### BRIEF DESCRIPTION OF DRAWINGS

The method and the UE are illustrated in the accompanying drawings, throughout which like reference letters indicate corresponding parts in the various figures. The embodiments herein will be better understood from the following description with reference to the drawings, in which:

FIG. 1A and FIG. 1B are signalling diagrams illustrating a scenario of how shall a UE determine whether the 5GMM reject cause value MBD, according to the prior arts;

FIG. 2 is a signalling diagram illustrating a scenario of how shall the UE determines whether the 5GMM reject cause value MBD, according to the embodiments as disclosed herein;

FIG. 3 is another signalling diagram illustrating a scenario of how shall the UE determines whether the 5GMM reject cause value MBD, according to the embodiments as disclosed herein;

FIG. 4 shows various hardware components of the UE, according to the embodiments as disclosed herein; and

FIG. 5A to FIG. 5C are flow charts illustrating a method for handling a disaster roaming service in the wireless network, according to the embodiments as disclosed herein.

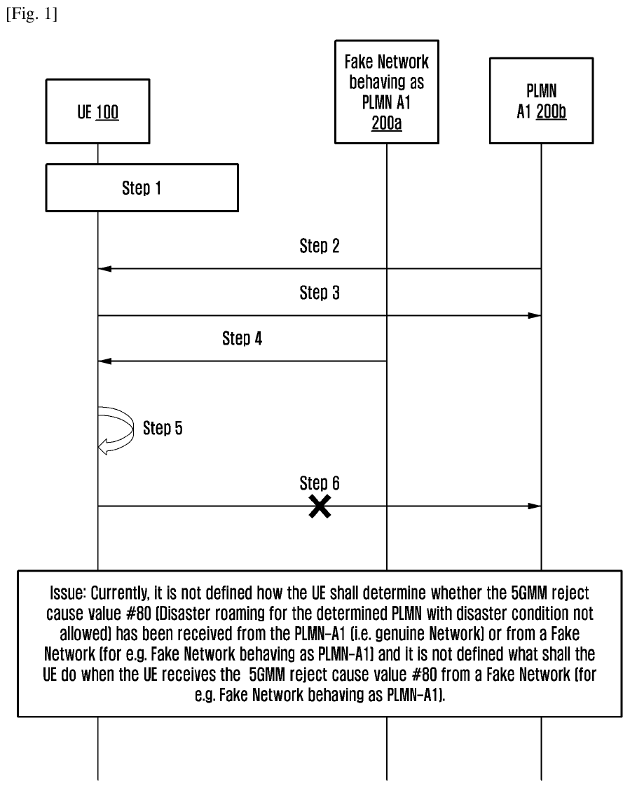

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Some of the abbreviations used in the description as follows:
a) 4G-GUTI—4G-Globally Unique Temporary Identifier
b) 5GCN—5G Core Network
c) 5G-GUTI—5G-Globally Unique Temporary Identifier
d) 5GMM—5GS Mobility Management
e) 5G-RG—5G Residential Gateway
f) 5G-BRG—5G Broadband Residential Gateway
g) 5G-CRG—5G Cable Residential Gateway
h) 5GS—5G System
i) 5GSM—5GS Session Management
j) 5G-S-TMSI—5G S-Temporary Mobile Subscription Identifier
k) 5G-TMSI—5G Temporary Mobile Subscription Identifier
l) 5QI—5G QoS Identifier
m) ACS—Auto-Configuration Server
n) AKA—Authentication and Key Agreement
o) AKMA—Authentication and Key Management for Applications
p) A-KID—AKMA Key Identifier
q) A-TID—AKMA Temporary Identifier
r) AMBR—Aggregate Maximum Bit Rate
s) AMF—Access and Mobility Management Function
t) APN—Access Point Name
u) ATSSS—Access Traffic Steering, Switching and Splitting
v) AUSF—Authentication Server Function
w) CAG—Closed access group
x) CHAP—Challenge Handshake Authentication Protocol
y) SUCI—Subscription Concealed Identifier
z) PLMN—Public Land Mobile Network
aa) MS—Mobile Station. The present document makes no distinction between MS and UE.
bb) UE—User Equipment
cc) ME—Mobile Equipment
dd) USIM—Universal Subscriber Identity Module
ee) UDM—Unified Data Management Function
ff) SIM—Subscriber Identity Module
gg) VPLMN—Visited PLMN
hh) HPLMN—Home PLMN
ii) MINT—Minimization of service interruption
jj) Visited PLMN (VPLMN): the VPLMN is a PLMN different from the HPLMN (if the EHPLMN list is not present or is empty) or different from an EHPLMN (if the EHPLMN list is present).
kk) Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service”in the MS.
ll) Available PLMN: PLMN(s) in the given area which is/are broadcasting capability to provide wireless communication services to the UE.
mm) Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
nn) EHPLMN: Any of the PLMN entries contained in the Equivalent HPLMN list.
oo) Equivalent HPLMN list: To allow provision for multiple HPLMN codes, PLMN codes that are present within a list shall replace the HPLMN code derived from the IMSI for PLMN selection purposes. The list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.
pp) Home PLMN: The home PLMN is a PLMN where the MCC and MNC of the PLMN identity match the MCC and MNC of the IMSI.
qq) Registered PLMN (RPLMN): The RPLMN is the PLMN on which certain LR (location registration which is also called as registration procedure) outcomes have occurred. In a shared network the RPLMN is the PLMN defined by the PLMN identity of the CN operator that has accepted the LR.
rr) Registration: The registration is the process of camping on a cell of the PLMN or the SNPN and doing any necessary LRs.
ss) UPLMN: PLMN/access technology combination in the “User Controlled PLMN Selector with Access Technology”data file in the SIM (in priority order);
tt) OPLMN: PLMN/access technology combination in the “Operator Controlled PLMN Selector with Access Technology” data file in the SIM (in priority order) or stored in the ME (in priority order).

Accordingly the embodiment herein is to provide a method for handling non integrity protected message in disaster situation.

Disaster Condition: The disaster condition is the condition that a government decides when to initiate and terminate, e.g. a natural disaster. When the condition applies, users may have the opportunity to mitigate service interruptions and failures.

Disaster Inbound Roamer: A user that (a) cannot get service from the PLMN, the Disaster Inbound Roamer would normally be served by, due to failure of service during a Disaster Condition, and (b) is able to register with other PLMNs.

Disaster Roaming: The disaster roaming is the special roaming policy that applies during a Disaster Condition.

PLMN with Disaster Condition: A PLMN to which a Disaster Condition applies.

Registered for disaster roaming services: A UE is considered as “registered for disaster roaming services” when the registered for disaster roaming services has successfully completed initial registration or mobility registration for disaster roaming services.

The terms disaster based service, disaster roaming service and disaster inbound roaming are used interchangeably in the embodiment and have the same meaning.

The terms disaster situation and disaster condition are used interchangeably in the embodiment and have the same meaning.

The terms PLMN D and PLMN-D are used interchangeably in the embodiment and have the same meaning.

The terms PLMN A and PLMN-A are used interchangeably in the embodiment and have the same meaning.

The terms UE and MS are used interchangeably in the embodiment and have the same meaning.

The term or method where “UE is registering for the disaster roaming service” or “UE is registered for the disaster roaming service” may refer to a situation or condition, but not restricted or limited to, where the UE sets or indicates the Fifth Generation System (5GS) Registration type IE to at least one of a “disaster roaming initial registration” and a “disaster roaming mobility registration updating” in the REGISTRATION REQUEST message.

The term area/location/geographical area are used in the embodiment may refer to any of cell/cell ID, TAC/TAI, PLMN, MCC/MNC, Latitude/longitude, CAG cell or any geographical location/coordinate.

The solutions explained in the embodiment are applicable to any (but not limited to) of the RAT(s) as defined in the embodiment.

The network used in the embodiment could be any 5G/EUTRAN Core Network Entities like AMF/SMF/MME/UPF or the Network could be any (but not limited to) 5G/EUTRAN RAN Entity like eNodeB (eNB) or gNodeB (gNB) or NG-RAN etc.

Below are example list of NAS messages refer to TS 24.50 1 for complete list (and not limited to)—
a) REGISTRATION REQUEST message;
b) DEREGISTRATION REQUEST message;
c) SERVICE REQUEST message; and
d) CONTROL PLANE SERVICE REQUEST.
e) IDENTITY REQUEST
f) AUTHENTICATION REQUEST;
g) AUTHENTICATION RESULT;
h) AUTHENTICATION REJECT;
i) REGISTRATION REJECT
j) REGISTRATION ACCEPT
k) DEREGISTRATION ACCEPT
l) SERVICE REJECT
m) UE CONFIGURATION UPDATE command
n) UE PARAMETERS UPDATE command

The term 5GMM sublayer states in the embodiment are at least one of the below—
1. 5GMM-NULL
2. 5GMM-DEREGISTERED
   a. 5GMM-DEREGISTERED.NORMAL-SERVICE
   b. 5GMM-DEREGISTERED.LIMITED-SERVICE
   c. 5GMM-DEREGISTERED.ATTEMPTING-REGISTRATION
   d. 5GMM-DEREGISTERED.PLMN-SEARCH
   e. 5GMM-DEREGISTERED.NO-SUPI
   f. 5GMM-DEREGISTERED.NO-CELL-AVAILABLE
   g. 5GMM-DEREGISTERED.eCALL-INACTIVE
   h. 5GMM-DEREGISTERED.INITIAL-REGISTRATION-NEEDED
3. 5GMM-REGISTERED-INITIATED
4. 5GMM-REGISTERED
   a. 5GMM-REGISTERED.NORMAL-SERVICE
   b. 5GMM-REGISTERED.NON-ALLOWED-SERVICE
   c. 5GMM-REGISTERED.ATTEMPTING-REGISTRATION-UPDATE
   d. 5GMM-REGISTERED.LIMITED-SERVICE
   e. 5GMM-REGISTERED.PLMN-SEARCH
   f. 5GMM-REGISTERED.NO-CELL-AVAILABLE
   g. 5GMM-REGISTERED.UPDATE-NEEDED
5. 5GMM-DEREGISTERED-INITIATED
6. 5GMM-SERVICE-REQUEST-INITIATED

In the embodiment, the term EMM sublayer states are at least one of the below—
1. EMM-NULL
2. EMM-DEREGISTERED
   a. EMM-DEREGISTERED.NORMAL-SERVICE
   b. EMM-DEREGISTERED.LIMITED-SERVICE
   c. EMM-DEREGISTERED.ATTEMPTING-TO-ATTACH
   d. EMM-DEREGISTERED.PLMN-SEARCH
   e. EMM-DEREGISTERED.NO-IMSI
   f. EMM-DEREGISTERED.ATTACH-NEEDED
   g. EMM-DEREGISTERED.NO-CELL-AVAILABLE
   h. EMM-DEREGISTERED.eCALL-INACTIVE
3. EMM-REGISTERED-INITIATED
4. EMM-REGISTERED
   a. EMM-REGISTERED.NORMAL-SERVICE
   b. EMM-REGISTERED.ATTEMPTING-TO-UPDATE
   c. EMM-REGISTERED.LIMITED-SERVICE
   d. EMM-REGISTERED.PLMN-SEARCH
   e. EMM-REGISTERED.UPDATE-NEEDED
   f. EMM-REGISTERED.NO-CELL-AVAILABLE
   g. EMM-REGISTERED.ATTEMPTING-TO-UPDATE-MM
   h. EMM-REGISTERED.IMSI-DETACH-INITIATED
5. EMM-DEREGISTERED-INITIATED
6. EMM-TRACKING-AREA-UPDATING-INITIATED
7. EMM-SERVICE-REQUEST-INITIATED

The term RAT as defined in the embodiment can be one of the following—
a) NG-RAN
b) 5G, 4G, 3G, 2G
c) EPS, 5GS
d) NR
   a. NR in unlicensed bands
   b. NR(LEO) satellite access
   c. NR(MEO) satellite access
   d. NR(GEO) satellite access
   e. NR(OTHERSAT) satellite access
   f. NR RedCap
   g. E-UTRA
   h. E-UTRA in unlicensed bands
   i. NB-IoT
   j. WB-IoT
   k. LTE-M
e) 5GS registration type are
   a. initial registration
   b. mobility registration updating
   c. periodic registration updating
   d. emergency registration
   e. SNPN onboarding registration
   f. “disaster roaming initial registration; or
   g. “disaster roaming mobility registration updating”
f) not set the registration type to disaster roaming initial registration or disaster roaming mobility registration updating means 5GS registration type is set to value other than “disaster roaming initial registration” or “disaster roaming mobility registration updating” at least one of:
   a. initial registration
   b. mobility registration updating
   c. periodic registration updating
   d. emergency registration
   e. SNPN onboarding registration

PLMN selection as per 23.122 without RPLMN—The MS selects and attempts registration on any PLMN/access technology combinations, if available and allowable, in the following order:
a) either the HPLMN (if the EHPLMN list is not present or is empty) or the highest priority EHPLMN that is available (if the EHPLMN list is present);
b) each PLMN/access technology combination in the “User Controlled PLMN Selector with Access Technology”data file in the SIM (in priority order);
c) each PLMN/access technology combination in the “Operator Controlled PLMN Selector with Access Technology” data file in the SIM (in priority order) or stored in the ME (in priority order);
d) other PLMN/access technology combinations with received high quality signal in random order;
e) other PLMN/access technology combinations in order of decreasing signal quality.

PLMN selection as per 23.122 with RPLMN—The MS selects and attempts registration on any PLMN/access technology combinations, if available and allowable, in the following order—
a) either the RPLMN or the Last registered PLMN;
b) either the HPLMN (if the EHPLMN list is not present or is empty) or the highest priority EHPLMN that is available (if the EHPLMN list is present);
c) each PLMN/access technology combination in the “User Controlled PLMN Selector with Access Technology” data file in the SIM (in priority order);
d) each PLMN/access technology combination in the “Operator Controlled PLMN Selector with Access Technology” data file in the SIM (in priority order) or stored in the ME (in priority order);
e) other PLMN/access technology combinations with received high quality signal in random order;
f) other PLMN/access technology combinations in order of decreasing signal quality.

Accordingly the embodiment herein is to disclose a method for handling a disaster roaming service in a wireless network. The method includes receiving, by a UE, a NAS message without integrity protection with a reject cause #80 from a first PLMN. Further, the method includes maintaining, by the UE, a count of attempt of a combination of the first PLMN and a second PLMN upon determining the NAS message without integrity protection is received with the reject cause #80. Further, the method includes starting, by the UE, a timer at the UE, blocking to retry for the disaster roaming service on the combination of the first PLMN and the second PLMN for the duration of the timer, and performing a PLMN selection. Further, the method includes unblocking the combination of the first PLMN and the second PLMN for the disaster roaming service at the expiry of the timer. Further, the method includes determining, by the UE, whether the UE receives a NAS message without integrity protection from the combination of the first PLMN and the second PLMN upon sending a registration request message to the combination of the first PLMN and the second PLMN after expiry of the timer. In an embodiment, the method includes determining the count of attempt to the combination of the first PLMN and the second PLMN meets a predefined threshold and determining that the first PLMN is genuine network in which the UE is not allowed to get the disaster roaming service and blocking to retry on the combination of the first PLMN and the second PLMN in response to receiving the NAS message without integrity protection from the combination of the first PLMN and the second PLMN upon sending the registration request message to the combination of the first PLMN and the second PLMN after expiry of the timer. In an embodiment, the method includes determining the count of attempt to the combination of the first PLMN and the second PLMN has not met a predefined threshold, increasing the counter, starting the timer, blocking to retry for the disaster roaming service on the combination of the first PLMN and the second PLMN for the duration of the timer, performing the PLMN selection in response to receiving the NAS message without integrity protection from the combination of the first PLMN and the second PLMN upon sending the registration request message to the combination of the first PLMN and the second PLMN after expiry of the timer. In an embodiment, the method includes determining that the NAS message with the reject cause #80 message is from a fake network and combination of the first PLMN and the second PLMN is allowed for the disaster roaming service in response to receiving the integrity protected registration accept from the combination of the first PLMN and the second PLMN upon sending the registration message to the combination of the first PLMN and the second PLMN after expiry of the timer. In an embodiment, the method includes determining that the combination of the first PLMN and the second PLMN is not allowed for the disaster roaming service in response to receiving the NAS reject message with the reject cause #80 which has been successfully integrity checked from the combination of the first PLMN and the second PLMN upon sending the registration message to the combination of the first PLMN and the second PLMN after expiry of the timer.

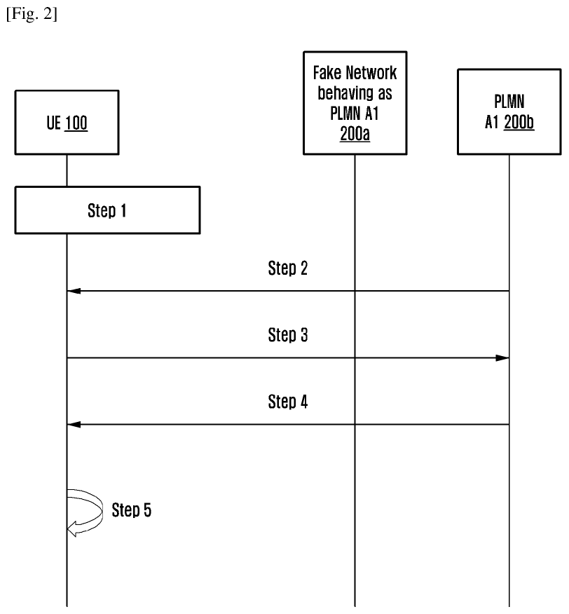

Referring now to the drawings and more particularly to FIGS. 2 through 5, where similar reference characters denote corresponding features consistently throughout the figures, there are shown preferred embodiments.

FIG. 2 is a signalling diagram illustrating a scenario of how shall the UE (100) determine whether the 5GMM reject cause value MBD, according to the embodiments as disclosed herein.

Consider, the PLMN-D1 is allowable PLMN for the UE (100) i.e., PLMN-D1 is not part of UE's Forbidden PLMN List (FPLMN List) and PLMN-D1 has faced disaster condition. PLMN-D2 is allowable PLMN for the UE (100) i.e., PLMN-D2 is not part of UE's Forbidden PLMN List (FPLMN List) and PLMN-D2 has faced disaster condition.

The PLMN-A1 is part of UE's Forbidden PLMN List (FPLMN List) or present in the list of “forbidden PLMNs” or present in the list of “forbidden PLMNs for GPRS service”. PLMN-A1 is alive and is broadcasting an indication of accessibility for Disaster Roaming Service to the UE (100). The PLMN-A can optionally broadcast a “list of one or more PLMN(s) with disaster condition (for e.g. PLMN-D1, PLMN-D2) for which disaster roaming is offered by the available PLMN”.

The UE (100) supporting Disaster Roaming or Minimization of Service Interruption (MINT), in the disaster condition, can select and register (through any AS or NAS signalling messages, for example-Registration Request message etc) for disaster roaming services using 5GS Registration Type value as “disaster roaming initial registration” or using 5GS Registration Type value as “disaster roaming mobility registration updating” on a PLMN (PLMN-A1) which is present in the Forbidden PLMN List (FPLMN List) of the UE (100) and providing disaster roaming services to the UE (100) on behalf of the determined PLMN with disaster condition (for e.g. PLMN-D1, which is allowable or not a part of UE's Forbidden PLMN List and has faced the disaster condition).

However, there may be a fake network (200a) or spoofing network (any network entity such as gNB or AMF etc) which may pretend to behave as the network entity for PLMN-A1. When the UE (100) is registering on the PLMN-A1 for the disaster roaming services for the PLMN-D1 which has faced disaster condition, the fake network (200a) (for e.g. fake network (200a) behaving as PLMN-A1) may reject the registration request of the UE (100) (through any AS or NAS signalling messages, for example-Registration Reject message etc) with the 5GMM reject cause value #80 (Disaster roaming for the determined PLMN with disaster condition not allowed).

The UE (100) shall check if the REGISTRATION REJECT message or any AS or NAS signalling message with 5GMM cause #80 (Disaster roaming for the determined PLMN with disaster condition not allowed) is integrity-protected or without any integrity protection.

The UE (100) shall perform at-least one of the below procedure, in any order or combinations:
a. If the UE (100) initiates the registration procedure for disaster roaming (using 5GS Registration Type value as “disaster roaming initial registration”) on PLMN-A1 and the PLMN-A1 (for ex-AMF of PLMN-A1) or any fake network (200a) or spoofing network (any Network Entity such as gNB or AMF etc) which may pretend to behave as the Network Entity for PLMN-A1 (for e.g. Fake Network behaving as PLMN-A1) sends a REGISTRATION REJECT message with 5GMM cause #80 (Disaster roaming for the determined PLMN with disaster condition not allowed), then the UE (100) shall perform at-least one of the below procedure, in any order or combinations:
   i. The UE (100) shall abort the initial registration procedure, set the 5GS update status to 5U2 NOT UPDATED, enter state 5GMM-DEREGISTERED. ATTEMPTING-REGISTRATION or any of the 5GMM sublayer states and shall delete any 5G-GUTI, last visited registered TAI, TAI list and ngKSI. Additionally, the UE (100) shall reset the registration attempt counter. The UE (100) shall not attempt to register for disaster roaming on the PLMN (i.e., PLMN-A1) for the determined PLMN with disaster condition (i.e., PLMN-D1) for a period in the range of 12 to 24 hours. The UE (100) shall not attempt to register for disaster roaming on the PLMN (i.e., PLMN-A1) for a period in the range of 3 to 10 minutes. The UE (100) shall perform PLMN selection as described in 3GPP TS 23.122 or PLMN selection as per 23.122 without RPLMN or PLMN selection as per 23.122 with RPLMN.
   ii. If the message has been successfully integrity checked by the NAS and the UE (100) maintains the PLMN-specific attempt counter and the PLMN-specific attempt counter for non-3GPP access for that PLMN (i.e., PLMN-A1), the UE (100) shall set the PLMN-specific attempt counter and the PLMN-specific attempt counter for non-3GPP access for that PLMN (i.e., PLMN-A1) to the UE implementation-specific maximum value.
   iii. If the message was received via 3GPP access and the UE (100) is operating in single-registration mode, the UE (100) shall in addition set the EPS update status to EU2 NOT UPDATED, reset the attach attempt counter and enter the state EMM-DEREGISTERED.
   iv. If the message has been successfully integrity checked by the NAS and the UE (100) also supports the registration procedure over the other access to the same PLMN (i.e., PLMN-A1), the UE (100) shall in addition handle 5GMM parameters and 5GMM state for the access, as described for the 5GMM cause value in the embodiment.
b. If the UE (100) initiates the registration procedure for disaster roaming (using 5GS Registration Type value as “disaster roaming mobility registration updating”) on PLMN-A1 and the PLMN-A1 (for ex-AMF of PLMN-A1) or any fake network (200a) or spoofing network (any Network Entity such as gNB or AMF etc) which may pretend to behave as the Network Entity for PLMN-A1 (for e.g. fake network (200a) behaving as PLMN-A1) sends a REGISTRATION REJECT message with 5GMM cause #80 (Disaster roaming for the determined PLMN with disaster condition not allowed), then the UE (100) shall perform at-least one of the below procedure, in any order or combinations:
   i. The UE (100) shall abort the registration procedure for mobility and periodic registration update procedure, set the 5GS update status to 5U2 NOT UPDATED and enter state 5GMM-REGISTERED. ATTEMPTING-REGISTRATION-UPDATE or any of the 5GMM sublayer states. Additionally, the UE (100) shall reset the registration attempt counter. The UE (100) shall not attempt to register for disaster roaming on the PLMN (i.e. PLMN-A1) for the determined PLMN (i.e. PLMN-D1) with disaster condition for a period in the range of 12 to 24 hours. The UE (100) shall not attempt to register for disaster roaming on the PLMN (i.e. PLMN-A1) for a period in the range of 3 to 10 minutes. The UE (100) shall perform PLMN selection as described in 3GPP TS 23.122 or PLMN selection as per 23.122 without RPLMN or PLMN selection as per 23.122 with RPLMN.
   ii. If the message has been successfully integrity checked by the NAS and the UE (100) maintains the PLMN-specific attempt counter and the PLMN-specific attempt counter for non-3GPP access for that PLMN (i.e. PLMN-A1), the UE (100) shall set the PLMN-specific attempt counter and the PLMN-specific attempt counter for non-3GPP access for that PLMN (i.e. PLMN-A1) to the UE implementation-specific maximum value.
   iii. If the message was received via 3GPP access and the UE (100) is operating in single-registration mode, the UE (100) shall in addition set the EPS update status to EU2 NOT UPDATED, reset the attach attempt counter and enter the state EMM-DEREGISTERED.
   iv. If the message has been successfully integrity checked by the NAS and the UE (100) also supports the registration procedure over the other access to the same PLMN (i.e. PLMN-A1), the UE (100) shall in addition handle 5GMM parameters and 5GMM state for the access, as described for the 5GMM cause value in the embodiment.
c. Optionally, the ME may store in its memory an extension of the “forbidden PLMNs” list. The contents of the extension of the list shall be deleted when the MS is switched off or the SIM is removed. A VPLMN (for e.g. PLMN-A1) may be stored in the extension of the “forbidden PLMNs” list if a message with cause value “PLMN not allowed” or “Requested service option not authorized in the PLMN” or “Serving network not authorized” or “Disaster roaming for the determined PLMN with disaster condition not allowed” is received by an MS in response to an LR request or REGISTRATION REQUEST message or any NAS or AS Signalling message from that VPLMN, and the following is valid:
   i. the MS is not configured to use timer T3245, the message is not integrity-protected, the MS maintains a list of PLMN-specific attempt counters and the value of the PLMN-specific attempt counter for that VPLMN (for e.g. PLMN-A1) is less than an MS implementation specific maximum value as defined in 3GPP TS 24.008, 3GPP TS 24.301 and 3GPP TS 24.501.
d. If the UE (100) is not configured to use timer T3245 (as defined in 3GPP TS 24.368 or 3GPP TS 31.102) and receives a REGISTRATION REJECT message without integrity protection with 5GMM cause value #80 (Disaster roaming for the determined PLMN with disaster condition not allowed), optionally from the PLMN-A1 (for ex-AMF of PLMN-A1) or any fake network (200a) or spoofing network (any Network Entity such as gNB or AMF etc) which may pretend to behave as the network entity for PLMN-A1 (for e.g. fake network (200a) behaving as PLMN-A1) when the UE (100) is registering for disaster roaming services on PLMN-A1, the UE (100) shall maintain at-least one of the below, in any order or combinations:
   i. a list of PLMN-specific attempt counters (as defined in 3GPP TS 24.301). The maximum number of possible entries in the list is implementation dependent. The list is applicable to access attempts via 3GPP access only;
   ii. a list of PLMN-specific attempt counters for non-3GPP access, if the UE (100) supports non-3GPP access. The maximum number of possible entries in the list is implementation dependent. The list is applicable to access attempts via non-3GPP access only;
   iii. a list of PLMN-specific N1 mode attempt counters for 3GPP access. The maximum number of possible entries in the list is implementation dependent. The list is applicable to access attempts via 3GPP access only;
   iv. a list of PLMN-specific N1 mode attempt counters for non-3GPP access, if the UE (100) supports non-3GPP access. The maximum number of possible entries in the list is implementation dependent. The list is applicable to access attempts via non-3GPP access only;
   v. one counter for “SIM/USIM considered invalid for GPRS services” events (as defined in 3GPP TS 24. 008); and
   vi. one counter for “USIM considered invalid for 5GS services over non-3GPP access”events, if the UE (100) supports non-3GPP access.
   vii. The UE (100) supporting non-EPS services shall maintain one counter for “SIM/USIM considered invalid for non-GPRS services” events (as defined in 3GPP TS 24.008). The UE (100) shall store the above lists of attempt counters and the event counters in its non-volatile memory. The UE (100) shall erase the lists and reset the event counters to zero when the UICC containing the USIM is removed. The counter values shall not be affected by the activation or deactivation of MICO mode or power saving mode (as defined in 3GPP TS 24.301). The UE implementation-specific maximum value for any of the above counters shall not be greater than 10. (NOTE: Different counters can use different UE implementation-specific maximum values.)
e. If the UE (100) receives a REGISTRATION REJECT message(or any NAS message) without integrity protection with 5GMM cause value #80 (Disaster roaming for the determined PLMN with disaster condition not allowed), optionally from the PLMN-A1 (for ex-AMF of PLMN-A1) or any fake network (200a) or spoofing network (any Network Entity such as gNB or AMF etc) which may pretend to behave as the network entity for PLMN-A1 (for e.g. fake network (200a) behaving as PLMN-A1) when the UE (100) is registering for disaster roaming services on PLMN-A1, for example before the network has established secure exchange of NAS messages for the N1 NAS signalling connection, the UE (100) shall stop timer T3510 or T3517 if running, and start timer T3247 (as defined in 3GPP TS 24.008) with a random value uniformly drawn from the range between 30 minutes and 60 minutes or UE implementation dependent time or any other time range configured by network or signalled by network in one of the AS or NAS signaling message, if the timer is not running, and the UE (100) shall perform at-least one of the below procedure, in any order or combinations:
   i. if the 5GMM cause value received is #80, then:
      a) if the 5GMM cause value is received over 3GPP access, the UE (100) shall perform at-least one of the below procedure, in any order or combinations:
         a. set the 5GS update status to 5U2 NOT UPDATED, enter state 5GMM-DEREGISTERED. ATTEMPTING-REGISTRATION or state 5GMM-REGISTERED. ATTEMPTING-REGISTRATION-UPDATE or any of the 5GMM sublayer states and shall delete any 5G-GUTI, last visited registered TAI, TAI list and ngKSI. Additionally, the UE (100) shall reset the registration attempt counter;
         b. if the UE is operating in single-registration mode, the UE (100) shall in addition set the EPS update status to EU2 NOT UPDATED, reset the attach attempt counter and enter the state EMM-DEREGISTERED for the case when the EPS attach, tracking area updating procedure or service request procedure is rejected with the EMM cause of the same value in a NAS message without integrity protection;
         c. search for a suitable cell in another tracking area according to 3GPP TS 38.304 or 3GPP TS 36.304;
         d. as a UE implementation option, the UE (100) may perform registration attempt over the non-3GPP access, if non-3GPP access is available, the UE (100) is not registered over non-3GPP access yet, and the USIM is not considered invalid for 5GS services over non-3GPP access; and/or
         e. if the PLMN-specific attempt counter for the PLMN sending the reject message (for e.g. PLMN-A1) has a value less than a UE implementation-specific maximum value, the UE (100) shall increment the PLMN-specific attempt counter for the PLMN;
         f. If the “SIM/USIM considered invalid for GPRS services” has a value less than a UE implementation-specific maximum value, the UE (100) shall increment the SIM/USIM considered invalid for GPRS services.
      b) if the 5GMM cause value is received over non-3GPP access, the UE (100) shall:
         a. set the 5GS update status to 5U2 NOT UPDATED, enter state 5GMM-DEREGISTERED. ATTEMPTING-REGISTRATION or state 5GMM-REGISTERED. ATTEMPTING-REGISTRATION-UPDATE or any of the 5GMM sublayer states and shall delete any 5G-GUTI, last visited registered TAI, TAI list and ngKSI for non-3GPP access. Additionally, the UE (100) shall reset the registration attempt counter;
         b. As a UE implementation option, the UE (100) may perform registration attempt over the non-3GPP access if another access point for non-3GPP access is available, or if 3GPP access is available, the UE (100) is not registered over 3GPP access yet, and the USIM is not considered invalid for 5GS services over 3GPP access, perform registration attempt over the 3GPP access; and/or
         c. if the PLMN-specific attempt counter for non-3GPP access for the PLMN (for e.g. PLMN-A1)sending the reject message has a value less than a UE implementation-specific maximum value, the UE (100) shall increment the PLMN-specific attempt counter for non-3GPP access for the PLMN;
f. Upon expiry of timer T3247, The UE (100) shall perform at-least one of the below procedure, in any order or combinations—
   i. remove all tracking areas from the list of “5GS forbidden tracking areas for regional provision of service” and the list of “5GS forbidden tracking areas for roaming”, which were stored in these lists for non-integrity protected NAS reject message;
   ii. set the USIM to valid for 5GS services for 3GPP access, if:
   iii. the counter for “SIM/USIM considered invalid for GPRS services” events has a value less than a UE implementation-specific maximum value;
   iv. set the USIM to valid for 5GS services for non-3GPP access, if:
   v. the counter for “USIM considered invalid for 5GS services over non-3GPP access” events has a value less than a UE implementation-specific maximum value;
   vi. set the USIM to valid for non-EPS services, if:
   vii. the counter for “SIM/USIM considered invalid for non-GPRS services” events has a value less than a UE implementation-specific maximum value;
   viii. for each PLMN-specific attempt counter that has a value greater than zero and less than a UE implementation-specific maximum value, remove the respective PLMN (for e.g. PLMN-A1) from the extension of the “forbidden PLMNs” list;
   ix. for each PLMN-specific attempt counter for non-3GPP access that has a value greater than zero and less than a UE implementation-specific maximum value, remove the respective PLMN (for e.g. PLMN-A1) from the list of “forbidden PLMNs for non-3GPP access to 5GCN”;
   x. re-enable the N1 mode capability for 3GPP access and, for each PLMN-specific N1 mode attempt counter for 3GPP access that has a value greater than zero and less than a UE implementation-specific maximum value, remove the respective PLMN from the list of PLMNs where N1 mode is not allowed for 3GPP access (as defined in 3GPP TS 23.122);
   xi. re-enable the N1 mode capability for non-3GPP access and, for each PLMN-specific N1 mode attempt counter for non-3GPP access that has a value greater than zero and less than a UE implementation-specific maximum value, remove the respective PLMN from the list of PLMNs where N1 mode is not allowed for non-3GPP access;
   xii. if the UE (100) is supporting A/Gb mode or Iu mode, perform the actions as specified in 3GPP TS 24.008 for the case when timer T3247 expires;
   xiii. if the UE (100) is supporting S1 mode, perform the actions as specified in 3GPP TS 24.301 for the case when timer T3247 expires; and
   xiv. initiate a registration procedure, if still needed, dependent on 5GMM state and 5GS update status, or perform PLMN selection according to 3GPP TS 23.122.
   xv. The PLMN which is marked as not allowed for disaster roaming, should be marked or remembered by the UE (100) that the respective PLMN is allowed to operate for disaster roaming. i.e. the UE (100) is allowed to operate on respective PLMN for disaster roaming and it can select and send registration request for disaster roaming services.

When the UE (100) is switched off, the UE (100) shall, for each PLMN-specific attempt counter that has a value greater than zero and less than the UE implementation-specific maximum value, remove the respective PLMN from the list of “forbidden PLMNs”. When the USIM is removed, the UE (100) should perform the action.

When the UE (100) is switched off, the UE (100) shall, for each PLMN-specific attempt counter for non-3GPP access that has a value greater than zero and less than the UE implementation-specific maximum value, remove the respective PLMN from the list of “forbidden PLMNs for non-3GPP access to 5GCN”. When the USIM is removed, the UE (100) should perform the action. (NOTE: If the respective PLMN was stored in the extension of the “forbidden PLMNs” list, then according to 3GPP TS 23.122 the UE (100) will delete the contents of the extension when the UE (100) is switched off or the USIM is removed.). The counter and timer names in the embodiment are only for illustration purpose and those can be given any name without deviating from the meaning and its usage.

As shown in FIG. 2, at step 1, the UE (100) detects that the disaster happened on PLMN-D1, PLMN-D2. At step 2, the PLMN-A1 broadcasts the indication of accessibility for Disaster Roaming Service (optionally broadcast a “list of one or more PLMN(s) with disaster condition (for e.g. PLMN-D1, PLMN-D2) for which disaster roaming is offered by the available PLMN” (i.e., PLMNs with disaster condition for which PLMN-A1 is providing disaster roaming services). At step 3, the UE (100) registers using 5GS Registration Type value as “disaster roaming initial registration” or using 5GS Registration Type value as “disaster roaming mobility registration updating” on PLMN A1 for Disaster Roaming service for the determined PLMN with disaster condition (PLMN-D1).

At step 4, the PLMN-A1, on which UE (100) is registering for Disaster Roaming services for PLMN-D1 which has faced disaster condition, rejects the registration request of the UE (through any AS or NAS signalling messages, for example-Registration Reject message etc) with the 5GMM reject cause value #80 (Disaster roaming for the determined PLMN with disaster condition not allowed).

At step 5, the UE (100) shall check if the REGISTRATION REJECT message or any AS or NAS signalling message with 5GMM cause #80 (Disaster roaming for the determined PLMN with disaster condition not allowed) is integrity-protected or without any integrity protection. If the UE receives a REGISTRATION REJECT message with 5GMM cause value #80 and has been successfully integrity checked by the NAS, the UE may determine that it is a genuine network which does not support providing disaster roaming services for the determined PLMN with disaster condition (e.g. PLMN-D1) to the UE (100).

The UE (100) shall abort the registration procedure, set the 5GS update status to 5U2 NOT UPDATED, enter state 5GMM-DEREGISTERED.ATTEMPTING-REGISTRATION or state 5GMM-REGISTERED.ATTEMPTING-REGISTRATION-UPDATE or any of the 5GMM sublayer states and shall delete any 5G-GUTI, last visited registered TAI, TAI list and ngKSI. Additionally, the UE shall reset the registration attempt counter. The UE shall not attempt to register for disaster roaming on this PLMN (i.e. PLMN-A1) for the determined PLMN with disaster condition (i.e. PLMN-D1) for a period in the range of 12 to 24 hours. The UE shall not attempt to register for disaster roaming on this PLMN (i.e. PLMN-A1) for a period in the range of 3 to 10 minutes. The UE shall perform PLMN selection as described in 3GPP TS 23.122 or PLMN selection as per 23.122 without RPLMN or PLMN selection as per 23.122 with RPLMN.

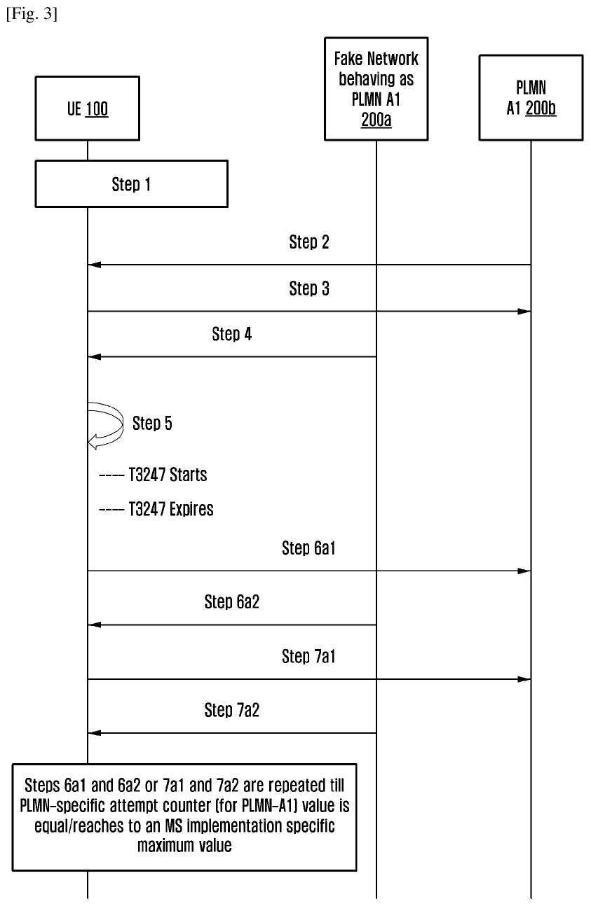

FIG. 3 is another signalling diagram illustrating a scenario of how shall the UE (100) determine whether the 5GMM reject cause value, according to the embodiments as disclosed herein.

The PLMN-D1 is allowable PLMN for the UE (100) i.e. PLMN-D1 is not part of UE's Forbidden PLMN List (FPLMN List) and PLMN-D1 has faced disaster condition. The PLMN-D2 is allowable PLMN for the UE (100) i.e. PLMN-D2 is not part of UE's Forbidden PLMN List (FPLMN List) and PLMN-D2 has faced disaster condition.

The PLMN-A1 is part of UE's Forbidden PLMN List (FPLMN List) or present in the list of “forbidden PLMNs” or present in the list of “forbidden PLMNs for GPRS service”. PLMN-A1 is alive and is broadcasting an indication of accessibility for Disaster Roaming Service to the UE (100). PLMN-A can optionally broadcast a “list of one or more PLMN(s) with disaster condition (for e.g. PLMN-D1, PLMN-D2) for which disaster roaming is offered by the available PLMN”.

The UE (100) supporting Disaster Roaming or Minimization of Service Interruption (MINT), in a disaster condition, can select and register (through any AS or NAS signalling messages, for example-Registration Request message etc) for disaster roaming services using 5GS Registration Type value as “disaster roaming initial registration” or using 5GS Registration Type value as “disaster roaming mobility registration updating” on a PLMN (PLMN-A1) which is present in the Forbidden PLMN List (FPLMN List) of the UE (100) and providing disaster roaming services to the UE (100) on behalf of the determined PLMN with disaster condition (for e.g. PLMN-D1, which is allowable or not a part of UE's Forbidden PLMN List and has faced the disaster condition).

However, there may be a fake network (200a) or spoofing network (any Network Entity such as gNB or AMF etc) which may pretend to behave as the Network Entity for PLMN-A1. When the UE (100) is registering on PLMN-A1 for Disaster Roaming services for PLMN-D1 which has faced disaster condition, the fake network (200a) (for e.g. fake network (200a) behaving as PLMN-A1) may reject the registration request of the UE (through any AS or NAS signalling messages, for example—Registration Reject message etc) with the 5GMM reject cause value #80 (Disaster roaming for the determined PLMN with disaster condition not allowed).

The UE (100) shall check if the REGISTRATION REJECT message or any AS or NAS signalling message with 5GMM cause #80 (Disaster roaming for the determined PLMN with disaster condition not allowed) is integrity-protected or without any integrity protection.

If the UE (100) receives a REGISTRATION REJECT message with 5GMM cause value #80 and has been successfully integrity checked by the NAS, the UE (100) may determine that it is a genuine network which does not support providing disaster roaming services for the determined PLMN with disaster condition (e.g. PLMN-D1) to the UE (100).

The UE (100) shall abort the registration procedure, set the 5GS update status to 5U2 NOT UPDATED, enter state 5GMM-DEREGISTERED.ATTEMPTING-REGISTRATION or state 5GMM-REGISTERED.ATTEMPTING-REGISTRATION-UPDATE or any of the 5GMM sublayer states and shall delete any 5G-GUTI, last visited registered TAI, TAI list and ngKSI. Additionally, the UE (100) shall reset the registration attempt counter. The UE (100) shall not attempt to register for disaster roaming on the PLMN (i.e. PLMN-A1) for the determined PLMN with disaster condition (i.e. PLMN-D1) for a period in the range of 12 to 24 hours or some other time range based on implementation. The UE (100) shall not attempt to register for disaster roaming on the PLMN (i.e. PLMN-A1) for a period in the range of 3 to 10 minutes. The UE (100) shall perform PLMN selection as described in 3GPP TS 23.122 or PLMN selection as per 23.122 without RPLMN or PLMN selection as per 23.122 with RPLMN.

If the UE (100) receives a REGISTRATION REJECT message without integrity protection with 5GMM cause value #80, the UE may determine that it is a fake network (200a) which is sending the reject cause.

The UE (100) shall stop timer T3510 or T3517 if running, and start timer T3247 (as defined in 3GPP TS 24.008) with a random value uniformly drawn from the range between 30 minutes and 60 minutes or any other implementation dependent time, if the timer is not running, and if the PLMN-specific attempt counter for the PLMN sending the reject message (for e.g. PLMN-A1) has a value less than a UE implementation-specific maximum value, the UE (100) shall increment the PLMN-specific attempt counter for the PLMN. The UE (100) will not consider the PLMN as a candidate to receive disaster roaming services i.e. UE (100) will not select and register on the PLMN to receive disaster roaming services till the timer T3247 is running. Optionally, the UE (100) will not consider the PLMN as a candidate to receive disaster roaming services i.e. the UE will not select and register on the PLMN to receive disaster roaming services for the MS determined PLMN with disaster condition using which the UE (100) received the non-integrity protected reject message with cause code #80. For example if the UE (100) attempted on disaster roaming registration on PLMN-A1 and indicated MS determined PLMN with disaster condition as PLMN-D1 then the UE (100) will not attempt disaster roaming service on PLMN-A1 with MS determined PLMN with disaster condition as PLMN-D1, but the UE (100) is allowed to attempt disaster roaming service on PLMN-A1 with MS determined PLMN with disaster condition as PLMN-D2. i.e. The UE (100) shall not attempt to register for disaster roaming on the PLMN (i.e. PLMN-A1) for the determined PLMN with disaster condition (i.e. PLMN-D1) for the duration of the timer T3247. Optionally, the UE (100) shall not attempt to register for disaster roaming on the PLMN (i.e. PLMN-A1) for the duration of the timer T3247.

Upon expiry of timer T3247, for each PLMN-specific attempt counter that has a value greater than zero and less than the UE implementation-specific maximum value, the UE (100) shall remove the respective PLMN (for e.g. PLMN-A1) from the extension of the “forbidden PLMNs” list and initiate a registration procedure, if still needed, dependent on 5GMM state and 5GS update status, or perform PLMN selection according to 3GPP TS 23.122 or PLMN selection as per 23.122 without RPLMN or PLMN selection as per 23.122 with RPLMN.

If PLMN-specific (e.g. PLMN-A1 specific) attempt counter value is equal/reaches to an MS implementation specific maximum value, the UE (100) may determine that the may be a genuine network which does not support providing disaster roaming services for the determined PLMN with disaster condition (e.g. PLMN-D1) to the UE (100) and the UE (100) shall apply same behaviour as if the received NAS message is successfully integrity checked by the NAS i.e. The UE (100) shall abort the registration procedure, set the 5GS update status to 5U2 NOT UPDATED, enter state 5GMM-DEREGISTERED.ATTEMPTING-REGISTRATION or state 5GMM-REGISTERED.ATTEMPTING-REGISTRATION-UPDATE or any of the 5GMM sublayer states and shall delete any 5G-GUTI, last visited registered TAI, TAI list and ngKSI. Additionally, the UE (100) shall reset the registration attempt counter. The UE (100) shall not attempt to register for disaster roaming on the PLMN (i.e. PLMN-A1) for the determined PLMN with disaster condition (i.e. PLMN-D1) for a period in the range of 12 to 24 hours or some other time range based on implementation. The UE (100) shall not attempt to register for disaster roaming on the PLMN (i.e. PLMN-A1) for a period in the range of 3 to 10 minutes. The UE (100) shall perform PLMN selection as described in 3GPP TS 23.122 or PLMN selection as per 23.122 without RPLMN or PLMN selection as per 23.122 with RPLMN.

While the UE (100) is maintaining the counters discussed in the embodiment if the integrity protected REGISTRATION ACCEPT message is received and integrity protection check is successful, for an attempt for disaster roaming service then the UE (100) shall reset the respective counters and consider that PLMN-A1 can provide disaster roaming services to the UE (100).

In an embodiment, the UE (100) registers using 5GS Registration Type value as “disaster roaming initial registration” or using 5GS Registration Type value as “disaster roaming mobility registration updating” on the PLMN A1 for the Disaster Roaming service, if still needed, for the determined PLMN with disaster condition (PLMN-D1) if the PLMN-specific attempt counter (for PLMN-A1) has a value greater than zero and less than the UE implementation-specific maximum value. The fake network or spoofing network rejects the registration request of the UE (100) with the 5GMM reject cause value #80

The UE (100) registers using 5GS Registration Type value as “disaster roaming initial registration” or using 5GS Registration Type value as “disaster roaming mobility registration updating” on PLMN A1 for Disaster Roaming service, if still needed, for the determined PLMN with disaster condition (PLMN-D1) if the PLMN-specific attempt counter (for PLMN-A1) has a value greater than zero and less than a UE implementation-specific maximum value. The fake network or the spoofing network rejects the registration request of the UE (100) with the 5GMM reject cause value #80.

As shown in FIG. 3, at step 1, the UE (100) detects that disaster happened on PLMN-D1, and PLMN-D2. At step 2, the PLMN-A1 broadcasts an indication of accessibility for the disaster roaming service (optionally broadcast a “list of one or more PLMN(s) with disaster condition (for e.g. PLMN-D1, PLMN-D2) for which disaster roaming is offered by the available PLMN” (i.e. PLMNs with disaster condition for which PLMN-A1 is providing disaster roaming services).

At step 3, the UE (100) registers using 5GS Registration Type value as “disaster roaming initial registration” or using 5GS Registration Type value as “disaster roaming mobility registration updating” on the PLMN A1 for Disaster Roaming service for the determined PLMN with disaster condition (PLMN-D1). At step 4, The fake network or spoofing network (any Network Entity such as gNB or AMF etc) which may pretend to behave as the Network Entity for PLMN-A1, on which UE is registering for Disaster Roaming services for PLMN-D1 which has faced disaster condition, rejects the registration request of the UE (through any AS or NAS signalling messages, for example-Registration Reject message etc) with the 5GMM reject cause value #80 (Disaster roaming for the determined PLMN with disaster condition not allowed).

At step 5, the UE shall check if the REGISTRATION REJECT message or any AS or NAS signalling message with 5GMM cause #80 (Disaster roaming for the determined PLMN with disaster condition not allowed) is integrity-protected or without any integrity protection. If the UE receives a REGISTRATION REJECT message without integrity protection with 5GMM cause value #80, the UE may determine that it is a Fake Network which is sending the reject cause. The UE shall stop timer T3510 or T3517 if running, and start timer T3247 (as defined in 3GPP TS 24.008) with a random value uniformly drawn from the range between 30 minutes and 60 minutes, if the timer is not running, and if the PLMN-specific attempt counter for the PLMN sending the reject message (for e.g. PLMN-A1) has a value less than a UE implementation-specific maximum value, the UE shall increment the PLMN-specific attempt counter for the PLMN. The UE shall store PLMN-A1 in the extension of the “forbidden PLMNs” list, if not stored already and the MS is not configured to use timer T3245, the message is not integrity-protected, the MS maintains a list of PLMN-specific attempt counters and the value of the PLMN-specific attempt counter for that VPLMN (for e.g. PLMN-A1) is less than an MS implementation specific maximum value. Upon expiry of timer T3247, for each PLMN-specific attempt counter that has a value greater than zero and less than a UE implementation-specific maximum value, the UE shall remove the respective PLMN (for e.g. PLMN-A1) from the extension of the “forbidden PLMNs” list and initiate a registration procedure, if still needed, dependent on 5GMM state and 5GS update status, or perform PLMN selection according to 3GPP TS 23.122 or PLMN selection as per 23.122 without RPLMN or PLMN selection as per 23.122 with RPLMN).

The T3247 starts and the T3247 expires. At step 6a1, the UE (100) registers using 5GS Registration Type value as “disaster roaming initial registration” or using 5GS Registration Type value as “disaster roaming mobility registration updating” on PLMN A1 for Disaster Roaming service, if still needed, for the determined PLMN with disaster condition (PLMN-D1) if the PLMN-specific attempt counter (for PLMN-A1) has a value greater than zero and less than a UE implementation-specific maximum value. At step 6a2, the fake network or spoofing network rejects the registration request of the UE with the 5GMM reject cause value #80

At step 7a1, The UE (100) registers using 5GS Registration Type value as “disaster roaming initial registration” or using 5GS Registration Type value as “disaster roaming mobility registration updating” on PLMN A1 for Disaster Roaming service, if still needed, for the determined PLMN with disaster condition (PLMN-D1) if the PLMN-specific attempt counter (for PLMN-A1) has a value greater than zero and less than a UE implementation-specific maximum value. At step 7a2, the fake network or spoofing network rejects the registration request of the UE with the 5GMM reject cause value #80.

Steps 6a1 and 6a2 or 7a1 and 7a2 are repeated till PLMN-specific attempt counter (for PLMN-A1) value is equal/reaches to an MS implementation specific maximum value.

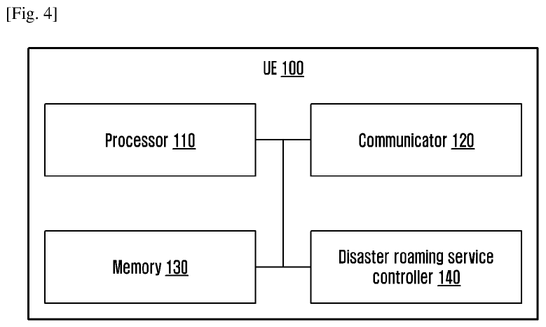

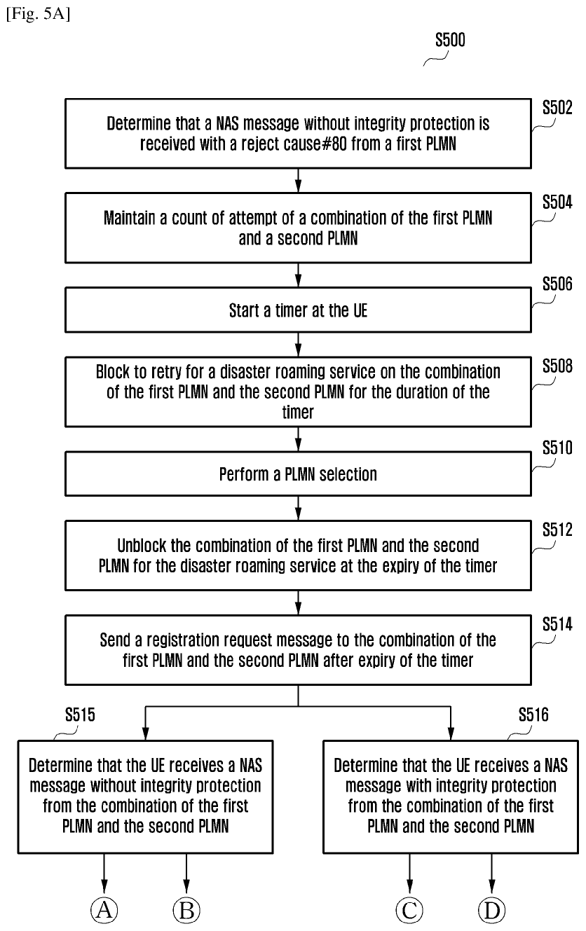

FIG. 4 shows various hardware components of the UE (100), according to the embodiments as disclosed herein. In an embodiment, the UE (100) includes a processor (110), a communicator (120), a memory (130) and a disaster roaming service controller (140). The processor (110) is coupled with the communicator (120), the memory (130) and the disaster roaming service controller (140).

The disaster roaming service controller (140) receives a NAS message without integrity protection with a reject cause #80 from a first PLMN. In an embodiment, the NAS message without integrity protection is at least one of a registration reject message or a service reject message which is not integrity protected.

Further, the disaster roaming service controller (140) maintains the count of attempt of the combination of the PLMN and the second PLMN upon determining the NAS message without integrity protection is received with the reject cause #80. In an embodiment, the first PLMN is the selected PLMN on which the registration is attempted by the UE (100) for the disaster roaming service. The second PLMN is the UE selected PLMN with the disaster condition.

Further, the disaster roaming service controller (140) starts the timer at the UE (100), blocks to retry for the disaster roaming service on the combination of the first PLMN and the second PLMN for the duration of the timer, and performs the PLMN selection. In an embodiment, the timer can be the timer T3247. Further, the disaster roaming service controller (140) unblocks the combination of the first PLMN and the second PLMN for the disaster roaming service at the expiry of the timer. Further, the disaster roaming service controller (140) determines whether the UE (100) receives the NAS message without integrity protection from the combination of the first PLMN and the second PLMN upon sending the registration request message to the combination of the first PLMN and the second PLMN after expiry of the timer. In an embodiment, the disaster roaming service controller (140) determines the count of attempt to the combination of the first PLMN and the second PLMN meets the predefined threshold and determines that the first PLMN is genuine network in which the UE (100) is not allowed to get the disaster roaming service and blocking to retry on the combination of the first PLMN and the second PLMN in response to receiving the NAS message without integrity protection from the combination of the first PLMN and the second PLMN upon sending the registration request message to the combination of the first PLMN and the second PLMN after expiry of the timer. In an embodiment, the UE (100) is not allowed to attempt for the disaster roaming service on the combination of the first PLMN and the second PLMN by setting the counter to the UE implementation specific maximum value.

In an embodiment, the terms counter, PLMN-specific attempt counter for the determined PLMN with the disaster condition and PLMN-specific attempt counter are used which refer to the same meaning.

IN this embodiment, there are triggers for e.g. to initiate registration procedure is described after expiry of the timer, which implies anytime (immediately or after certain duration) after the expiry of the timer

In an embodiment, the disaster roaming service controller (140) determines the count of attempt to the combination of the first PLMN and the second PLMN has not met the predefined threshold, increases the counter, starts the timer, blocks to retry for the disaster roaming service on the combination of the first PLMN and the second PLMN for the duration of the timer, performs the PLMN selection in response to receiving the NAS message without integrity protection from the combination of the first PLMN and the second PLMN upon sending the registration request message to the combination of the first PLMN and the second PLMN after expiry of the timer. In an embodiment, the counter is the PLMN-specific attempt counter for the determined PLMN with the disaster condition.

In an embodiment, the disaster roaming service controller (140) determines that the NAS message with the reject cause #80 message is from the fake network (200a) and combination of the first PLMN and the second PLMN is allowed for the disaster roaming service in response to receiving the integrity protected registration accept from the combination of the first PLMN and the second PLMN upon sending the registration message to the combination of the first PLMN and the second PLMN after expiry of the timer.

In an embodiment, the integrity protected NAS message is at least one of the registration reject message and the registration accept message which has been successfully integrity checked by the NAS message.

In an embodiment, the disaster roaming service controller (140) determines that the combination of the first PLMN and the second PLMN is not allowed for the disaster roaming service in response to receiving the NAS reject message with the reject cause #80 which has been successfully integrity checked from the combination of the first PLMN and the second PLMN upon sending the registration message to the combination of the first PLMN and the second PLMN after expiry of the timer.

The disaster roaming service controller (140) may be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 4 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

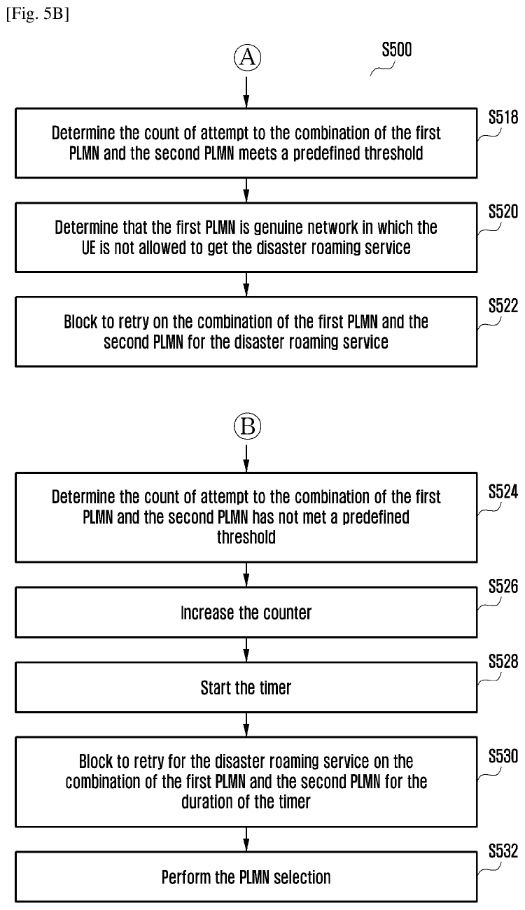

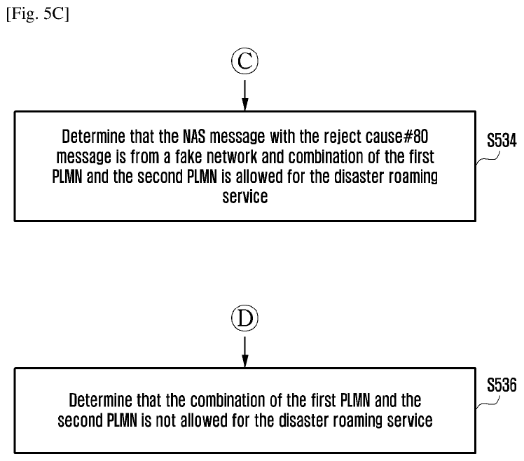

FIG. 5A to FIG. 5C are flow charts (S500) illustrating a method for handling a disaster roaming service in the wireless network (1000), according to the embodiments as disclosed herein. The operations (S502-S536) are handled by the disaster roaming service controller (140).

At step S502, the method includes determining that the NAS message without integrity protection is received with the reject cause #80 from the first PLMN. At step S504, the method includes maintaining the count of attempt of a combination of the first PLMN and the second PLMN. At step S506, the method includes starting the timer at the UE (100). At step S508, the method includes blocking to retry for the disaster roaming service on the combination of the first PLMN and the second PLMN for the duration of the timer. At step S510, the method includes performing the PLMN selection.

At step S512, the method includes unblocking the combination of the first PLMN and the second PLMN for the disaster roaming service at the expiry of the timer. At step S514, the method includes sending the registration request message to the combination of the first PLMN and the second PLMN after expiry of the timer. At step S515, the method includes determining that the UE (100) receives the NAS message without integrity protection from the combination of the first PLMN and the second PLMN. At step S516, the method includes determining that the UE (100) receives the NAS message with the integrity protection from the combination of the first PLMN and the second PLMN.

In response to receiving the NAS message without integrity protection from the combination of the first PLMN and the second PLMN upon sending the registration request message to the combination of the first PLMN and the second PLMN after expiry of the timer (which can be immediate of expiry of timer or after certain duration of expiry of timer), at step S518, the method includes determining the count of attempt to the combination of the first PLMN and the second PLMN meets a predefined threshold(The predefined threshold in this embodiment is the UE implementation specific maximum value of the counter at which UE determines the network is genuine). At step S520, the method includes determining that the first PLMN is genuine network in which the UE (100) is not allowed to get the disaster roaming service. At step S522, the method includes blocking to retry on the combination of the first PLMN and the second PLMN for the disaster roaming service.

In response to receiving the NAS message without integrity protection from the combination of the first PLMN and the second PLMN upon sending the registration request message to the combination of the first PLMN and the second PLMN after expiry of the timer, at step S524, the method includes determining the count of attempt to the combination of the first PLMN and the second PLMN has not met the predefined threshold. At step S526, the method includes increasing the counter. At step S528, the method includes starting the timer. At step S530, the method includes blocking to retry for the disaster roaming service on the combination of the first PLMN and the second PLMN for the duration of the timer. At step S532, the method includes performing the PLMN selection.

In response to receiving the integrity protected registration accept from the combination of the first PLMN and the second PLMN upon sending the registration message to the combination of the first PLMN and the second PLMN after expiry of the timer, at step S534, the method includes determining that the NAS message with the reject cause #80 message is from the fake network and combination of the first PLMN and the second PLMN is allowed for the disaster roaming service.

In response to receiving the NAS reject message with the reject cause #80 which has been successfully integrity checked from the combination of the first PLMN and the second PLMN upon sending the registration message to the combination of the first PLMN and the second PLMN after expiry of the timer, at step S536, the method includes determining that the combination of the first PLMN and the second PLMN is not allowed for the disaster roaming service.

The various actions, acts, blocks, steps, or the like in the flow charts (S500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless network, the method comprising:
receiving a Non-access stratum (NAS) message without integrity protection with a reject cause #80 from a first Public Land Mobile Network (PLMN);
maintaining a PLMN-specific attempt counter for the first PLMN;
starting a timer at the UE;
incrementing the PLMN-specific attempt counter on receiving a NAS message without integrity protection with a reject cause #80 when the timer is running; and
considering the first PLMN is available for disaster roaming service, in case that the timer is expired and the PLMN-specific attempt counter has a value greater than zero and less than a maximum value.

2. The method of claim 1, wherein the NAS message without integrity protection is at least one of a registration reject message or a service reject message which is not integrity protected.

3. The method of claim 1, further comprising:
receiving a NAS message which is successfully integrity checked; and
setting the PLMN-specific counter to the maximum value.

4. The method of claim 1, wherein the PLMN-specific attempt counter is for the first PLMN associated with a second PLMN which is a determined PLMN with the disaster condition.

5. The method of claim 1, wherein the UE is not allowed to attempt for the disaster roaming service on a combination of the first PLMN and the second PLMN in case that the PLMN-specific attempt counter has the maximum value.

6. The method of claim 1, wherein the timer is set to random value between 30 minutes and 60 minutes when started.

7. The method of claim 1, wherein the timer is a timer T3247.

8. A user equipment (UE) in a wireless network, the UE comprising:
a memory;
a processor; and
a controller, communicatively coupled to the memory and the processor, configured to:
receive a Non-access stratum (NAS) message without integrity protection with a reject cause #80 from a first Public Land Mobile Network (PLMN);
maintain a PLMN-specific attempt count for the first PLMN;
start a timer at the UE;
increment the PLMN-specific attempt counter on receiving a NAS message without integrity protection with a reject cause #80 when the timer is running, and
consider the first PLMN is available for disaster roaming service, in case that the timer is expired and the PLMN-specific attempt counter has a value greater than zero and less than a maximum value.

9. The UE of claim 8, wherein the NAS message without integrity protection is at least one of a registration reject message or a service reject message which is not integrity protected.

10. The UE of claim 8,
wherein the controller is further configured to:
receive a NAS message which is successfully integrity checked, and
set the PLMN-specific counter to the maximum value.

11. The UE of claim 8, wherein the PLMN-specific attempt counter is for the first PLMN associated with a second PLMN which is a determined PLMN with the disaster condition.

12. The UE of claim 8, wherein the UE is not allowed to attempt for the disaster roaming service on a combination of the first PLMN and the second PLMN in case that the PLMN-specific attempt counter has the maximum value.

13. The UE of claim 8, wherein the timer is set to random value between 30 minutes and 60 minutes when started.

14. The UE of claim 8, wherein the timer is a timer T3247.
